(19) United States
(12) Patent Application Publication
(10) Pub. No.: US 2010/0171815 A1
(43) Pub. Date: Jul. 8, 2010

(54) IMAGE DATA OBTAINING METHOD AND APPARATUS THEREFOR

(76) Inventors: Hyun-soo PARK, Seoul (KR); Du-seop Yoon, Suwon-si (KR)

Correspondence Address: North Star Intellectual Property Law, PC, P.O. Box 34688, Washington, DC, 20043, US

(21) Appl. No.: 12/650,917

(22) Filed: Dec. 31, 2009

(30) Foreign Application Priority Data
Jan. 2, 2009 (KR) 10-2009-0000115

(51) Int. Cl. H04N 13/02

(52) U.S. Cl. 348/47; 348/E13.074

(57) ABSTRACT

An image data obtaining method to obtain three-dimensional (3D) image data by using a plurality of pieces of two-dimensional (2D) image data obtained by capturing an image of a scene, the image data obtaining method including: setting a focal length of an image-capturing device so as to allow a reference component, from among a plurality of components of the scene, to be focused; obtaining the plurality of pieces of 2D image data by using different aperture values in the image-capturing device having the set focal length; and obtaining the 3D image data by using a relation between the plurality of pieces of 2D image data.

### CROSS-REFERENCE TO RELATED APPLICATION

This application claims the benefit of Korean Patent Application No. 10-2009-0000115, filed on Jan. 2, 2009 in the Korean Intellectual Property Office, the disclosure of which is incorporated herein in its entirety by reference.

### BACKGROUND OF THE INVENTION

1. Field of the Invention

Aspects of the present invention relate to an image data obtaining method and apparatus therefor, and more particularly, to an image data obtaining method and apparatus therefor to obtain three-dimensional (3D) image data.

2. Description of the Related Art

Due to developments in information communication technologies, three-dimensional (3D) image technologies have become more widespread. 3D image technology is aimed at realizing a realistic image by applying depth information to a two-dimensional (2D) image.

Since human eyes are separated in a horizontal direction by a predetermined distance, 2D images respectively viewed by a left eye and a right eye are different from each other such that binocular disparity occurs. The human brain combines the different 2D images to generate a 3D image having the appearance of perspective and reality. Specifically, in order to provide a 3D image, 3D image data including depth information may be generated, or 2D image data may be converted to generate 3D image data.

### SUMMARY OF THE INVENTION

Aspects of the present invention provide an image data obtaining method and apparatus therefor to efficiently obtain three-dimensional (3D) image data.

According to an aspect of the present invention, there is provided an image data obtaining method to obtain 3D image data by using a plurality of pieces of two-dimensional (2D) image data obtained by capturing an image of a scene, the image data obtaining method including: setting a focal length of an image-capturing device so as to allow a reference component, from among a plurality of components of the scene, to be focused; obtaining the plurality of pieces of 2D image data by using different aperture values in the image-capturing device having the set focal length; and obtaining the 3D image data by using a relation between the plurality of pieces of 2D image data.

The reference component may be a first component positioned closest to the image-capturing device or a second component positioned farthest from the image-capturing device from among the plurality of components.

The setting of the focal length may include: setting a plurality of focal length measurement areas in the scene; measuring focal lengths at which the plurality of focal length measurement areas are respectively focused on; and determining one of the plurality of focal length measurement areas as the reference component according to the measured focal lengths.

The reference component may be a first focal length measurement area that is focused at a minimum focal length from among the plurality of focal length measurement areas.

The reference component may be a second focal length measurement area that is focused at a maximum focal length from among the plurality of focal length measurement areas.

The measuring of the focal lengths may include measuring the focal lengths when the aperture value of the image-capturing device is minimized.

The measuring of the focal lengths may include measuring the focal lengths when the aperture value of the image-capturing device is maximized.

The obtaining of the plurality of pieces of 2D image data may include obtaining first image data by capturing the image of the scene when the aperture value of the image-capturing device is minimized, and obtaining second image data by capturing the image of the scene when the aperture value of the image-capturing device is maximized.

The obtaining of the 3D image data may include: generating information indicating a focus deviation degree for each pixel in the second image data by comparing the first image data and the second image data; and generating a depth map corresponding to the plurality of pieces of 2D image data according to the generated information.

According to another aspect of the present invention, there is provided an image data obtaining apparatus to obtain 3D image data by using a plurality of pieces of 2D image data obtained by capturing an image of a scene, the image data obtaining apparatus including: a focal length setting unit to set a focal length of an image-capturing device so as to allow a reference component, from among a plurality of components of the scene, to be focused; a first obtaining unit to obtain the plurality of pieces of 2D image data by using different aperture values in the image-capturing device; and a second obtaining unit to obtain 3D image data by using a relation between the plurality of pieces of 2D image data.

According to yet another aspect of the present invention, there is provided an image data obtaining apparatus to obtain a plurality of pieces of two-dimensional (2D) image data by capturing an image of a scene, the plurality of pieces of 2D image data to be used to obtain three-dimensional (3D) image data, the image data obtaining apparatus including: a focal length setting unit to set a focal length of an image-capturing device so as to allow a reference component, from among a plurality of components of the scene, to be focused; a first obtaining unit to obtain the plurality of pieces of 2D image data by capturing the image using different aperture values in the image-capturing device having the set focal length, wherein a relation between the plurality of pieces of 2D image data is used to obtain the 3D image data.

According to still another aspect of the present invention, there is provided a computer-readable recording medium implemented by a computer, the computer readable recording medium including: first two-dimensional (2D) image data obtained by an image-capturing device capturing an image of a scene using a set focal length and a first aperture value; and second 2D image data obtained by the image-capturing device capturing the image of the scene using the set focal length and a second aperture value, different from the first aperture value, wherein a reference component, from among a plurality of components of the scene, is focused in the first and second 2D image data according to the set focal length, and the first and second 2D image data are used by the computer to obtain three-dimensional (3D) image data.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1A shows an image obtained by capturing a target object while an aperture of an image-capturing device is closed;

FIG. 1B shows an image obtained by capturing the target object while the aperture of the image-capturing device of FIG. 1A is opened;

FIG. 2 shows second image data obtained by using an image data obtaining apparatus according to an embodiment of the present invention;

FIG. 3 is a block diagram of an image data obtaining apparatus according to an embodiment of the present invention;

FIG. 4 is a block diagram of a focal length setting unit in the image data obtaining apparatus of FIG. 3;

FIG. 5 shows second image data obtained by using the image data obtaining apparatus according to the embodiment shown in FIG. 3;

FIG. 6 is a flowchart illustrating an image data obtaining method, according to an embodiment of the present invention; and

FIG. 7 is a flowchart illustrating an image data obtaining method, according to another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

In order to generate three-dimensional (3D) image data by using two-dimensional (2D) image data, information is used to indicate a distance between a target object and a camera. With respect to each pixel of the 2D image data, the information includes depth information indicating how far the camera is from an object indicated by each of the pixels.

In order to obtain the depth information, three methods may be used. One method to obtain depth information includes analyzing the shape of a captured image of the target object. This method is economical in view of using a piece of 2D image data. However, an object shape analyzing method and apparatus therefor are difficult to implement, such that the method is impractical.

Another method to obtain the depth information includes analyzing at least two pieces of 2D image data obtained by capturing images of the same target object from different angles. This method is easy to implement, and is, therefore, often used. However, in order to capture images of the same target object from different angles, an image-capturing device (e.g., a camera) uses a plurality of optical systems having different optical paths. Since optical systems are expensive items, such an image-capturing device having two or more optical systems is not economical.

Another method to obtain the 3D image data depth information includes analyzing at least two pieces of 2D image data obtained by capturing images of the same target object. The research conducted by A. Pentland, S. Scherock, T. Darrell, and B. Girod and entitled, “Simple range cameras based on focal error,” and incorporated herein by reference, discloses a method to obtain depth information by analyzing a focused image and a non-focused image. Equation 1 below is based on the aforementioned research and may be used to obtain depth information by using at least two pieces of 2D image data. In this regard, Equation 1 is one non-limited method to obtain 3D image data by using at least two pieces of 2D image data, and it is understood that embodiments of the present invention are not limited thereto. Equation 1 is as follows:

$${d}_{o} = \frac{fD}{D - f - 2 {krf}_{number}} , \qquad Equation 1$$

where f indicates a focus value of a camera lens, D indicates a distance between a camera and an image plane that is positioned between lenses, r indicates a radius of an area in which a captured image of a target object looks dim due to a focus error, k indicates a transform constant, and f_{number} indicates an f value of the camera. Furthermore, the f_{number} is calculated by dividing a focal length of the camera lens by a lens aperture value. In this regard, the aforementioned values, except for the r value, are related to physical conditions of the camera, and thus may be obtained when a capturing operation is performed. Hence, depth information may be obtained when the r value is obtained from the captured target image.

In Equation 1, the f value (i.e., the focus value of the camera lens) indicates a physical property of the camera lens, and may not be changed while an image of a target object is captured when using the same camera. However, the focal length is related to adjusting a distance between lenses so as to focus an image of the target object. Thus, while an image of the target object is being captured when using the same camera, the focal length may change.

With respect to Equation 1, in order to obtain the depth information by using at least two pieces of 2D image data, one of the two pieces of 2D image data may clearly display all components of a captured scene, and the other of the two pieces of 2D image data may clearly display some of the components of the captured scene while dimly displaying the rest of the components. Hereinafter, for convenience of description, image data clearly displaying all components in a scene is referred to as first image data, and image data clearly displaying only some of the components is referred to as second image data. Moreover, a component is a predetermined sized piece of the captured scene. Sizes of the components may be equivalent to each other or may vary. For example, when a scene including a standing person is captured, the person may be a component of the captured scene, or arms and legs of the person may be components of the captured scene.

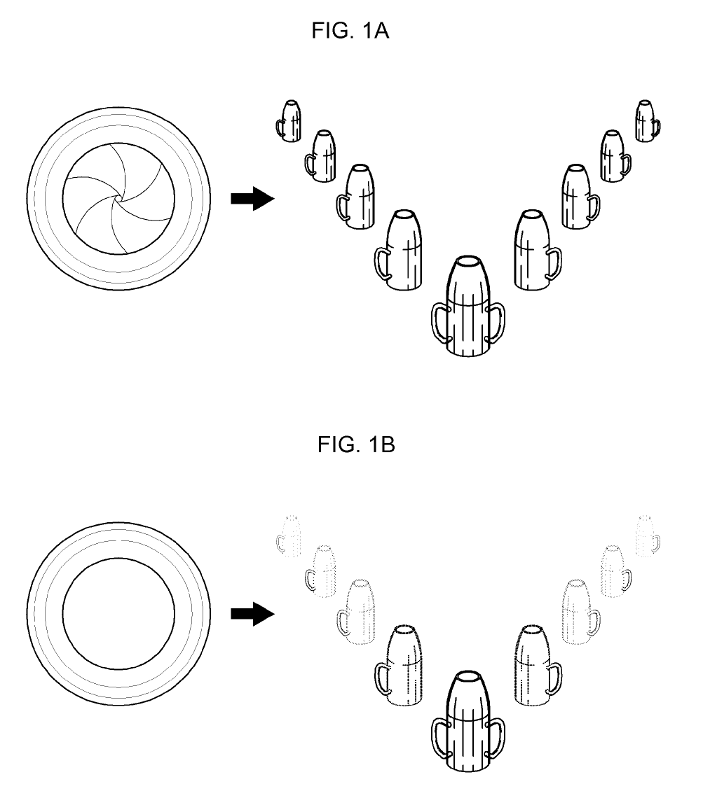

A method of obtaining first image data, which clearly display all components of a scene, and second image data, which clearly display only some of the components, includes capturing the scene and then capturing the same scene but after changing an aperture value in an image-capturing device. A detailed description of the method of capturing the same scene by using different aperture values will now be described with reference to FIGS. 1A and 1B.

FIG. 1A shows an image obtained by capturing an image of a target object while an aperture of an image-capturing device is closed. A left diagram of FIG. 1A corresponds to the image-capturing device having the closed aperture. When an image of the target object is captured while the aperture is closed, all components in a captured scene are clearly displayed as shown in a right diagram of FIG. 1A. Thus, first image data may be obtained by capturing an image of the target object while the aperture of the image-capturing device is closed.

FIG. 1B shows an image obtained by capturing an image of the target object of FIG. 1A while the aperture of the image-capturing device is opened. A left diagram of FIG. 1B corresponds to the image-capturing device having the opened aperture. When an image of the target object is captured while the aperture is opened, only some of the components in the captured scene are clearly displayed as shown in a right diagram of FIG. 1B. That is, only a focused area is clearly displayed, and a residual area is dimly displayed. Thus, second image data may be obtained by capturing an image of the target object while the aperture of the image-capturing device is opened. Referring to FIGS. 1A and 1B, first image data and second image data are obtained by using different aperture values of the image-capturing device. However, it is understood that a method of obtaining first image data and second image data is not limited thereto.

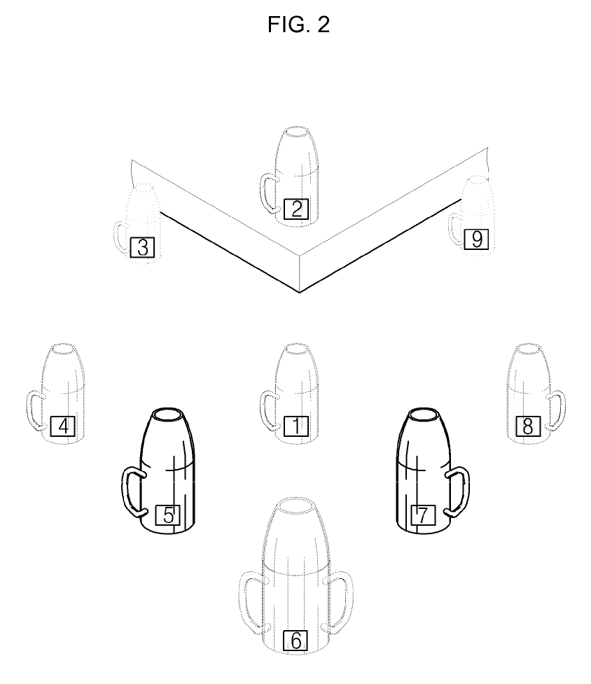

When first image data and second image data are obtained, depth information may be obtained by using Equation 1. In the case where the depth information is calculated according to Equation 1, it is possible to determine how far an object indicated by a corresponding pixel is distanced from a reference position (e.g., a camera). However, it is not possible to know whether the object indicated by the corresponding pixel is located in front of the reference position or behind a reference position in a scene. Hereinafter, this matter will be described with reference to FIG. 2.

FIG. 2 shows second image data obtained by using an image obtaining apparatus according to an embodiment of the present invention. In FIG. 2, sizes of all items are the same. Thus, the object(s) closer to the photographing apparatus are viewed greater.

Referring to FIG. 2, it is apparent that areas 5 and 7 in the second image data are clear. That is, the areas 5 and 7 are focused. When calculating the r value according to Equation 1, r values of the areas 5 and 7 are minimum values. At this time, the position of an object indicated by the area 5 or the area 7 becomes a reference position.

On the other hand, residual areas are dimly displayed compared to the areas 5 and 7. When calculating the r value according to Equation 1, it is possible to see that r values of the residual areas are greater than the r values of the areas 5 and 7. According to Equation 1, the r value becomes greater in proportion to a focus deviation degree. Thus, the greater an r value of an area is, the farther the position of an object in that area is from the reference position.

If a dimness degree (i.e., the focus deviation degree) is the same between areas 4, 1, 6 and 8, r values calculated according to Equation 1 are the same with respect to the areas 4, 1, 6 and 8. That is, objects respectively corresponding to the areas 4, 1, 6 and 8 are equally distanced from the reference position. However, it is not possible to know whether the objects corresponding to the areas 4, 1, 6 and 8 are positioned in front of the reference position or behind the reference position. That is, size information of the distance is provided but sign information is not provided. Thus, although an object in the area 4 may be 10 cm in front of an object in the area 5, and an object in an area 6 may be 10 cm behind the object in the area 5, the objects in both of the areas 4 and 6 may be mistakenly determined to be positioned in front of the reference position (or behind the reference position).

In order to solve the aforementioned problem, a focal length of the image obtaining apparatus may be adjusted to allow a component that is positioned farthest from among components in a target scene to be focused on so that second image data may be obtained. In this case, the components in the target scene are positioned closer to a reference position than the focused component. In a similar manner, the focal length may be adjusted to allow a component that is positioned closest from among the components in the target scene to be focused on so that second image data may be obtained. In this case, the components in the target scene are positioned farther from the reference position than the focused component.

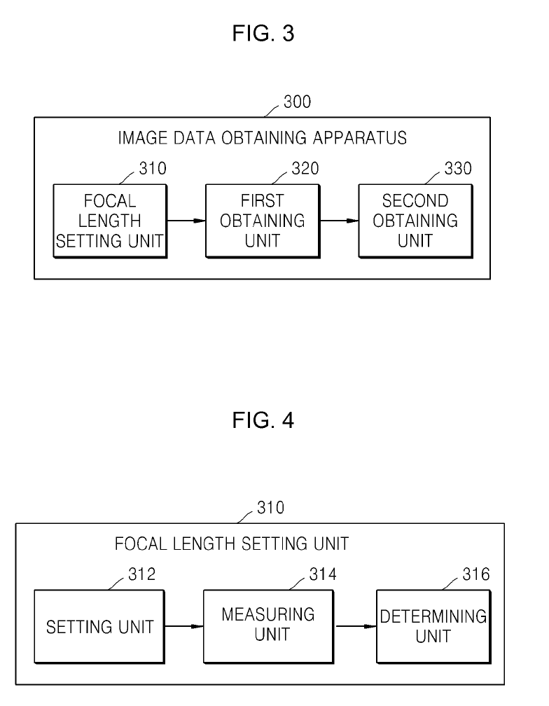

FIG. 3 is a block diagram of an image data obtaining apparatus 300 according to an embodiment of the present invention. Referring to FIG. 3, the image data obtaining apparatus 300 includes a focal length setting unit 310, a first obtaining unit 320, and a second obtaining unit 330. While not required, each of the units 310, 320, 330 can be one or more processors or processing elements on one or more chips or integrated circuits.

The focal length setting unit 310 sets a focal length of an image-capturing device so that a component satisfying a predetermined condition may be a reference component from among a plurality of components of a target scene. It is understood that the reference component may vary. For example, a first component from among the components that is positioned farthest from the image-capturing device may be the reference component. Also, a second component that is positioned closest to the image-capturing device may be the reference component.

In order to set the first component or the second component as the reference component, distances between the image-capturing device and the components of the target scene may be measured. However, to measure the distances between the image-capturing device and all of the components of the target scene is impractical. Thus, one or more areas in the target scene may be designated, distances between the designated areas and the image-capturing device may be measured, and then one of the designated areas is set as a reference position. A detailed description about setting the first component or the second component as the reference component will be described later with reference to FIG. 4.

The first obtaining unit 320 obtains a plurality of pieces of 2D image data by using different aperture values in the image-capturing device. At this time, a focal length of the image-capturing device may constantly maintain the focal length set by the focal length setting unit 310. In detail, the first obtaining unit 320 captures an image of a target object when the aperture value of the image-capturing device is set at a minimum value (for example, when the aperture is closed), and thus obtains first image data. After that, the first obtaining unit 320 captures an image of the target object when the aperture value of the image-capturing device is set at a maximum value, and thus obtains second image data. As described above, the second image data clearly displays a reference component, and dimly displays residual components.

The second obtaining unit 330 obtains 3D image data by using a relation between the plurality of pieces of 2D image data. The second obtaining unit 330 may include an information generating unit (not shown) and a depth map generating unit (not shown). The information generating unit (not shown) compares the first image data and the second image data to generate information indicating the focus deviation degree for each of pixels in the second image data. The information indicating the focus deviation degree is the r value of Equation 1. The depth map generating unit (not shown) generates a depth map corresponding to the plurality of pieces of 2D image data, according to the generated information.

FIG. 4 is a block diagram of the focal length setting unit 310 in the image data obtaining apparatus 300 of FIG. 3. Referring to FIG. 4, the focal length setting unit 310 includes a setting unit 312, a measuring unit 314, and a determining unit 316. While not required, each of the units 312, 314, 316 can be one or more processors or processing elements on one or more chips or integrated circuits.

The setting unit 312 sets one or more focal length measurement areas to be used in measuring a focal length in a scene. The one or more focal length measurement areas (hereinafter, referred to as “the one or more measurement areas”) may be directly set by a user or may be automatically set by the setting unit 312.

The measuring unit 314 measures focal lengths at which the one or more measurement areas are focused on, respectively. While not restricted thereto, the measuring unit 314 may use an auto focusing (AF) operation that enables a specific area to be focused on without user manipulation. By using such an AF operation, the focal lengths, at which the one or more measurement areas are focused, may by easily measured.

While measuring the focal lengths at which the one or more measurement areas are focused on, an aperture of the image-capturing device may be closed or opened. Whether one or more of the measurement areas are focused on may be correctly detected while the aperture of the image-capturing means is opened. Thus, measurement of the focal lengths at which one or more of the measurement areas are focused on may, although not necessarily, be conducted while the aperture of the image-capturing device is opened.

The determining unit 316 determines one of the one or more measurement areas as a reference component, according to the focal lengths at which the one or more of the measurement areas are focused. For example, the focal length measurement area focused at the lowest focal length may be the reference component, or the focal length measurement area focused at the greatest focal length may be the reference component.

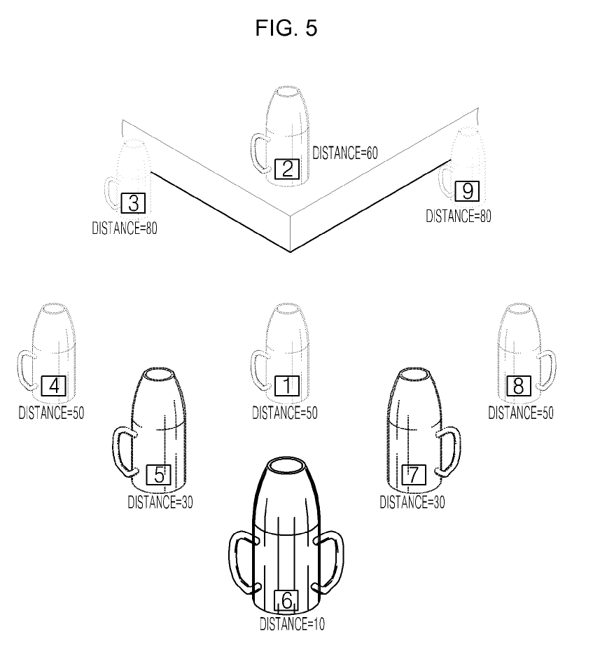

FIG. 5 shows second image data obtained by using the image data obtaining apparatus 300 according to the embodiment of FIG. 3. Referring to FIG. 5, the setting unit 312 sets nine measurement areas. Thus, the measuring unit 314 calculates focal lengths at which the 9 measurement areas are focused on, respectively. In this regard, for example, the focal length at which the measurement area 1 is focused is 50, the focal length at which the measurement area 6 is focused is 10, and the focal length at which the measurement area 2 is focused on is 60.

The determining unit 316 determines, from the nine measurement areas, one measurement area as a reference component, according to the focal lengths calculated by the measuring unit 314. At this time, the determining unit 316 may determine the measurement area that is focused on at the lowest focal length as the reference component, or may determine the measurement area that is focused on at the greatest focal length as the reference component. In the shown embodiment, the measurement area that is focused on at the lowest focal length is determined as the reference component. Thus, the measurement area 6 is determined as the reference component.

Accordingly, the first obtaining unit 320 obtains a plurality of pieces of 2D image data by using different aperture values while maintaining the focal length at that at which the measurement area 6 is focused on. For example, the first obtaining unit 320 obtains first image data by capturing an image of a target object when the aperture is closed, and obtains second image data by capturing an image of the target object when the aperture is opened. The second obtaining unit 330 obtains 3D image data by using a relation between the pieces of 2D image data. At this time, Equation 1 may be used.

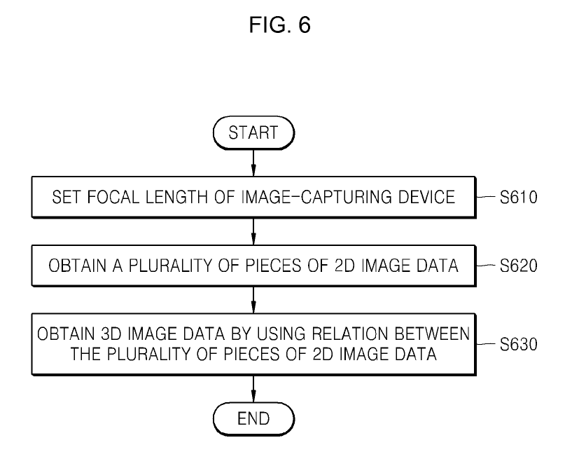

FIG. 6 is a flowchart illustrating an image data obtaining method, according to an embodiment of the present invention. Referring to FIG. 6, a focal length of an image-capturing device is set to allow a reference component to be focused on in operation S610. The reference component is a component satisfying a predetermined condition, from among a plurality of components of a target scene. For example, the reference component from among the plurality of components may be a first component positioned closest to the image-capturing device, or may be a second component positioned farthest from the image-capturing device.

A plurality of pieces of 2D image data are obtained by using different aperture values in the image-capturing device in operation S620. At this time, the focal length of the image-capturing device remains at the focal length that is set in operation S610. Accordingly, 3D image data is obtained by using a relation between the plurality of pieces of 2D image data in operation S630.

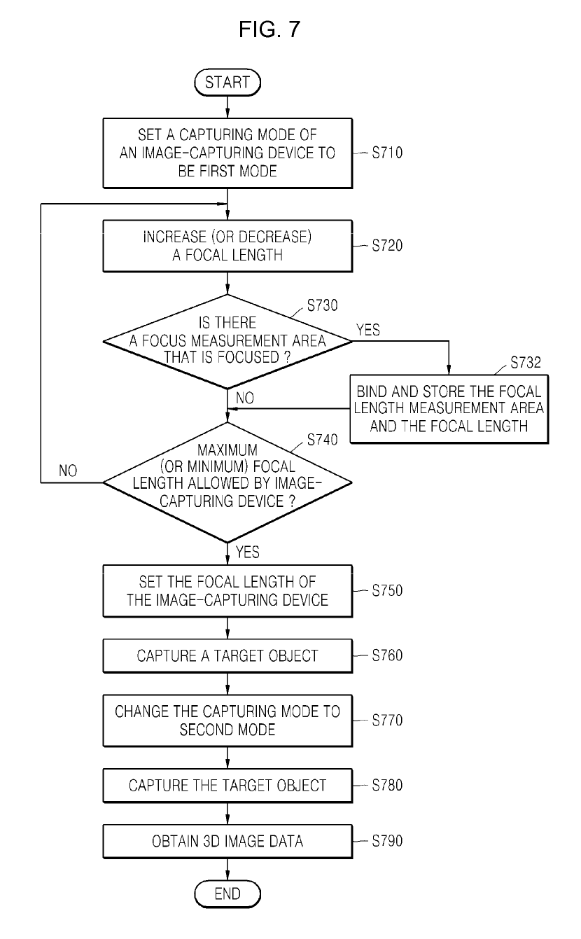

FIG. 7 is a flowchart of an image data obtaining method, according to another embodiment of the present invention. Referring to FIG. 7, a capturing mode of an image-capturing device is set to be a first mode. The capturing mode may be classified according to a closed-opened status of an aperture. For example, the first mode may indicate a status in which the aperture is completely opened to the extent that the image-capturing device allows, and a second mode may indicate a status in which the aperture is completely closed to the extent that the image-capturing device allows.

A focal length of the image-capturing device is increased (or decreased) in operation S720. At this time, the degree of an increase or decrease of the focal length may vary according to one or more embodiments.

Whether there is a measurement area focused on at a current focal length is determined in operation S730. A measurement area indicates an area to be used for measuring a focal length in a screen. Thus, if there is a measurement area focused at the current focal length (operation S730), the measurement area and the current focal length are bound and stored in operation S732.

If the current focal length is a maximum (or minimum) focal length that is allowed by the image-capturing device in operation S740, operation S750 is performed. However, if the current focal length is not the maximum (or minimum) focal length allowed by the image-capturing device in operation S740, operation S720 is performed again. In operation S750, a measurement area that is focused at the minimum focal length according to the stored focal length is determined to be a reference component. Accordingly, the focal length of the image-capturing device is set as the focal length at which the reference component is focused.

An image of a target object is captured by using the image-capturing device in operation S760. Since the first mode is a mode in which the aperture is opened, image data obtained in operation S760 corresponds to second image data that clearly displays only the reference component and dimly displays residual components.

The capturing mode is changed to the second mode in operation S770. An image of the target object is captured by using the image-capturing device in the second mode in operation S780. Since the second mode is a mode in which the aperture is closed, image data obtained in operation S780 corresponds to first image data that clearly displays all areas in a scene. 3D image data is obtained by using a relation between the first image data and the second image data in operation S790.

While not restricted thereto, aspects of the present invention can be written as computer programs and can be implemented in general-use digital computers that execute the programs using a computer-readable recording medium. Examples of the computer-readable recording medium include magnetic storage media (e.g., ROM, floppy disks, hard disks, etc.), optical recording media (e.g., CD-ROMs, or DVDs), etc. Aspects of the present invention may also be realized as a data signal embodied in a carrier wave and comprising a program readable by a computer and transmittable over the Internet.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An image data obtaining method to obtain three-dimensional (3D) image data by using a plurality of pieces of two-dimensional (2D) image data obtained by capturing an image of a scene, the image data obtaining method comprising:
setting a focal length of an image-capturing device so as to allow a reference component, from among a plurality of components of the scene, to be focused;
obtaining, by the image capturing device having the set focal length, the plurality of pieces of 2D image data by capturing the image using different aperture values in the image-capturing device; and
obtaining the 3D image data by using a relation between the plurality of pieces of 2D image data.

2. The image data obtaining method as claimed in claim 1, wherein the reference component is a first component positioned closest to the image-capturing device from among the plurality of components or a second component positioned farthest from the image-capturing device from among the plurality of components.

3. The image data obtaining method as claimed in claim 1, wherein the setting of the focal length comprises:
setting a plurality of focal length measurement areas in the scene;
measuring focal lengths at which the plurality of focal length measurement areas are respectively focused on; and
determining one of the plurality of focal length measurement areas as the reference component according to the measured focal lengths.

4. The image data obtaining method as claimed in claim 3, wherein the reference component is a first focal length measurement area, from among the plurality of focal length measurement areas, that is focused on at a minimum focal length, from among the measured focal lengths.

5. The image data obtaining method as claimed in claim 3, wherein the reference component is a second focal length measurement area, from among the plurality of focal length measurement areas, that is focused on at a maximum focal length, from among the measured focal lengths.

6. The image data obtaining method as claimed in claim 3, wherein the measuring of the focal lengths comprises measuring the focal lengths at which the plurality of focal length measurement areas are respectively focused on, when an aperture value of the image-capturing device is minimized.

7. The image data obtaining method as claimed in claim 3, wherein the measuring of the focal lengths comprises measuring the focal lengths at which the plurality of focal length measurement areas are respectively focused on, when an aperture value of the image-capturing device is maximized.

8. The image data obtaining method as claimed in claim 1, wherein the obtaining of the plurality of pieces of 2D image data comprises obtaining first image data by capturing the image of the scene when an aperture value of the image-capturing device is minimized, and obtaining second image data by capturing the image of the scene when the aperture value of the image-capturing device is maximized.

9. The image data obtaining method as claimed in claim 8, wherein the obtaining of the 3D image data comprises:
generating information indicating a focus deviation degree for each pixel in the second image data by comparing the first image data and the second image data; and
generating a depth map corresponding to the plurality of pieces of 2D image data according to the generated information.

10. The image data obtaining method as claimed in claim 3, wherein the setting of the focal length further comprises binding and storing each of the focal length measurement areas and the corresponding measured focal length.

11. The image data obtaining method as claimed in claim 8, wherein the reference component is focused in the second image data and remaining areas aside from the reference component are unfocused in the second image data.

12. An image data obtaining apparatus to obtain three-dimensional (3D) image data by using a plurality of pieces of two-dimensional (2D) image data obtained by capturing an image of a scene, the image data obtaining apparatus comprising:
a focal length setting unit to set a focal length of an image-capturing device so as to allow a reference component, from among a plurality of components of the scene, to be focused;
a first obtaining unit to obtain the plurality of pieces of 2D image data by capturing the image using different aperture values in the image-capturing device having the set focal length; and
a second obtaining unit to obtain the 3D image data by using a relation between the plurality of pieces of 2D image data.

13. The image data obtaining apparatus as claimed in claim 12, wherein the reference component is a first component positioned closest to the image-capturing device from among the plurality of components or a second component positioned farthest from the image-capturing device from among the plurality of components.

14. The image data obtaining apparatus as claimed in claim 12, wherein the focal length setting unit comprises:
a setting unit to set a plurality of focal length measurement areas in the scene;
a measuring unit to measure focal lengths at which the plurality of focal length measurement areas are respectively focused on; and
a determining unit to determine one of the plurality of focal length measurement areas as the reference component according to the measured focal lengths.

15. The image data obtaining apparatus as claimed in claim 14, wherein the reference component is a focal length measurement area, from among the plurality of focal length measurement areas, that is focused on at a minimum focal length, from among the measured focal lengths.

16. The image data obtaining apparatus as claimed in claim 14, wherein the reference component is a focal length measurement area, from among the plurality of focal length measurement areas, that is focused on at a maximum focal length, from among the measured focal lengths.

17. The image data obtaining apparatus as claimed in claim 14, wherein the measuring unit measures the focal lengths at which the plurality of focal length measurement areas are respectively focused on, when an aperture value of the image-capturing device is minimized.

18. The image data obtaining apparatus as claimed in claim 14, wherein the measuring unit measures the focal lengths at which the plurality of focal length measurement areas are respectively focused on, when an aperture value of the image-capturing device is maximized.

19. The image data obtaining apparatus as claimed in claim 12, wherein the first obtaining unit obtains first image data by capturing the image of the scene when an aperture value of the image-capturing device is minimized, and obtains second image data by capturing the image of the scene when the aperture value of the image-capturing device is maximized.

20. The image data obtaining apparatus as claimed in claim 19, wherein the second obtaining unit comprises:
an information generating unit to generate information indicating a focus deviation degree for each pixel in the second image data by comparing the first image data and the second image data; and
a depth map generating unit to generate a depth map corresponding to the plurality of pieces of 2D image data according to the generated information.

21. The image data obtaining apparatus as claimed in claim 14, wherein the focal length setting unit binds and stores each of the focal length measurement areas and the corresponding measured focal length.

22. The image data obtaining apparatus as claimed in claim 19, wherein the reference component is focused in the second image data and remaining areas aside from the reference component are unfocused in the second image data.

23. A computer-readable recording medium encoded with the method of claim 1 and implemented by at least one computer.
